(19) United States
(12) Patent Application Publication
(10) Pub. No.: US 2008/0319963 A1
(43) Pub. Date: Dec. 25, 2008

(54) Method for Providing Information in Data Communication Network Using Private Page

(76) Inventor: Han-Gu Kang, Gyeonggi-do (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/094,047

(22) PCT Filed: Apr. 10, 2006
(86) PCT No.: PCT/KR2006/001308

§ 371 Date: May 16, 2008

(30) Foreign Application Priority Data
Nov. 16, 2005 (KR) 10-2005-0109538

(51) Int. Cl. G06F 17/30

(52) U.S. Cl. 707/4; 707/E17.044; 707/E17.032

(57) ABSTRACT

Disclosed herein is a method for providing information in a data communication network using a private page. The method includes the steps of (a) a service providing server receiving necessary information from a searcher's terminal through a data communication network, and generating and storing a private page DataBase (DB); (b) the service providing server receiving necessary information from an information provider's terminal through the data communication network, and generating and storing an information provider DB; (c) the service providing server detecting the connection of the searcher's terminal to a private page through the data communication network; (d) the service providing server directly or indirectly receiving a search index with respect to information to be searched for from the searcher's terminal through a search window or a private search menu provided in the private page; and (e) the service providing server extracting an information provider corresponding to the received search index, and then providing information about the extracted information provider to the searcher's terminal or linking the searcher's terminal to a site managed by the extracted information provider.

### TECHNICAL FIELD

The present invention relates generally to a method for providing information in a data communication network using a private page and, more particularly, to a method for providing information in a data communication network using a private page, which connects to a private page provided through a wired or wireless data communication network, and allows various types of information to be more conveniently searched for and provided.

### BACKGROUND ART

Recently, wired and wireless data communication networks are rapidly popularized worldwide, so that a culture of transmitting information and services through a data communication network and enjoying the transmitted information and services is rapidly being established. A long time has passed since a wired data communication network, called the Internet, has been established as an essential tool for life. Recently, searching for necessary information and services via a wireless data communication network using mobile phones or Personal Digital Assistants (PDAs), and receiving the found information and services via the wireless data communication network has been popularized.

Ways of providing information and services via data communication networks are also being variously changed. Conventionally, the provision of services or information is performed in such a manner that numerous portal service providers and online service providers provide various types of content, such as searching, shopping, advance purchasing, broadcasting, news, entertainment, music, movies, chatting, game and studying, through a data communication network, and typical persons connect to web sites managed by the service providers, search for necessary information, and receive the found information. However, recently, beyond a level in which the unidirectional person-to-business information and services are provided, a culture in which users bi-directionally provide necessary person-to-person information while managing their private pages in the information communication network, as in mini-homepages provided by Cyworld or blogs provided by Naver, is being rapidly established.

According to recent statistics, as communication via the data communication network becomes an important means for maintaining modern people's human relationships, the frequency at which users connect to the data communication network to utilize their private pages is larger than that at which they connect to the data communication network to utilize commercial web sites.

### DISCLOSURE OF INVENTION

### Technical Problem

As described above, a culture of users sharing necessary information while managing their private pages in the data communication network is being activated, but tasks they can perform using the private pages are very limited. For example, currently, tasks the users can perform using the private pages provided through the wired data communication network are confined to uploading pictures or writings to show them to different persons, or to visiting different persons' private pages to leave personal greetings or messages on visitors' registers.

Accordingly, when a user connecting to a private page managed by himself or herself desires to utilize different types of content, such as searching, shopping, advance purchasing, broadcasting, news, entertainment, music, movies, chatting, game and studying, there is inconvenience in that the user must disconnect from the private page and then establish a connection to a site managed by an business which provides corresponding content. Such a problem is more serious for private pages provided through a wireless data communication network. The user must connect to a private page using a wireless data communication network access program provided by each communication company in order to utilize the private page using his or her own mobile phone. In this state, the user must disconnect from the wireless data communication network and establish a new connection in order to utilize a different type of content. This is very inconvenient work in consideration of the various aspects of a wireless data communication connection, such as a relative long access time, an expensive data packet fee, and inconvenience of using the number input-based keypad of a mobile phone. Accordingly, these become important factors that hinder the activation of the wireless communication network.

In consideration of the above problems, a new concept of information providing method that can conveniently search for and receive different types of necessary content, such as searching, shopping, advance purchasing, broadcasting, news, entertainment, music, movies, chatting, game and studying, in private pages in a currently activated data communication network is seriously required.

### Technical Solution

Accordingly, the present invention has been proposed to meet such demand of industry and Internet users, and an object of the present invention is to provide a method for providing information using a private page that allows various types of information to be conveniently searched for and provided through a search window or a private search menu provided in a private page in a data communication network.

In accordance with the present invention, users can utilize a new information providing method based on the concept of one-stop service, which can simultaneously provide person-to-business information, that is, various types of content provided by online service providers, as well as person-to-person information based on an existing method simply by connecting to their private pages managed in a data communication network.

In order to accomplish the above object, the present invention provides a method for providing information in a data communication network using a private page, the method including the steps of (a) a service providing server receiving necessary information from a searcher's terminal through a data communication network, and generating and storing a private page DataBase (DB); (b) the service providing server receiving necessary information from an information provider's terminal through the data communication network, and generating and storing an information provider DB; (c) the service providing server detecting the connection of the searcher's terminal to a private page through the data communication network; (d) the service providing server directly or indirectly receiving a search index with respect to information to be searched for from the searcher's terminal through a search window or a private search menu provided in the private page; and (e) the service providing server extracting an information provider corresponding to the received search index, and then providing information about the extracted information provider to the searcher's terminal or linking the searcher's terminal to a site managed by the extracted information provider.

Furthermore, the step (a) includes the steps of: (a-1) the service providing server detecting a connection of the searcher's terminal thereto for requesting generation of the private page through the data communication network; (a-2) the service providing server requesting the information, which is necessary to generate the private page, from the searcher's terminal, and receiving the corresponding information; and (a-3) the service providing server generating the private page, in which the search window and the private search menu are provided, using the received information, and storing the generated page to the private page DB.

It is preferred that the step (a-3) further include the step (a-4) of the service providing server extracting a series of search indexes, which are necessary to search for the private page, from the received information, and storing the extracted indexes to a search index DB.

Furthermore, the step (b) includes the steps of (b-1) the service providing server detecting the connection of an information provider's terminal thereto for requesting registration as an information provider through the data communication network; (b-2) the service providing server requesting information, which is necessary to register the information provider, from the information provider's terminal, and receiving the corresponding information; (b-3) the service providing server generating an information provider page in a search window is provided, or generating a search window on the page of a web site managed by the information provider, and then storing the generated search window to the information provider DB.

Furthermore, it is preferred that the step (b-3) further include the step (b-4) of the service providing server extracting a series of search indexes, which are necessary to search for the information provider, from the received information, and storing the extracted indexes to a search index DB.

Furthermore, at the step (d), the search index include numbers, characters, or a pre-determined number of dots, and allow the information provider to be directly extracted through the search window or to be indirectly extracted through a sub-menu linked to the search window or the private search menu.

Furthermore, the step (e) includes the steps of (e-1) the service providing server determining whether the received search index has been received through the search window or the private search menu; (e-2) the service providing server directly extracting the information provider using the search index or indirectly extracting the information provider through a sub-menu linked to the search window, if it is determined that the search index is received through the search window; (e-3) the service providing server indirectly extracting the information provider through the sub-menu linked to the private search menu using the search index if it is determined that the search index is received through the private search menu; and (e-4) the service providing server directly providing a page related to the extracted information provider to the searcher's terminal, or linking the searcher's terminal to a site managed by the extracted information provider.

Meanwhile, at the step (d), the private search menu is a menu basically provided by the service providing server, or a menu set up according to personal preference using bookmarked information received from the searcher's terminal.

### ADVANTAGEOUS EFFECTS

As described above, in accordance with a method for providing information in a data communication network using a private page according to present invention, a new concept of information providing method, which is capable of searching for all pieces of information desired in a private page that the user manages in person and receiving the found information, and performing all necessary tasks such as e-mail, fax, and phone call functions, can be popularized.

Particularly, in the wireless data communication network, the inconvenience that is attributable to frequent disconnection designated as the conventional problem, can be overcome, so that the use of the wireless data communication network can be remarkably extended.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a system for providing information according to the present invention;

FIG. 2 is a block diagram showing the construction of a service providing server according to the present invention;

FIG. 3 is a diagram showing an example of the private page of a searcher's terminal according to the present invention;

FIG. 4 is a diagram showing an example of the phone page of an information provider's terminal according to the present invention;

FIG. 5 is a flowchart illustrating a method for providing information according to the present invention;

FIG. 6 is a flowchart illustrating a process of registering a private page according to the present invention;

FIG. 7 is a flowchart illustrating a process of registering an information provider according to the present invention;

FIG. 8 is a flowchart illustrating a process of providing information according to the present invention;

FIG. 9 is a diagram illustrating of a process of directly providing information using a search window according to an embodiment of the present invention;

FIG. 10 is a diagram illustrating a process of indirectly providing information using search windows according to an embodiment of the present invention;

FIG. 11 is a diagram illustrating a process of providing information using a private search menu according to an embodiment of the present invention;

FIG. 12 is a diagram illustrating a process of providing information according to another embodiment of the present invention; and

FIG. 13 is a diagram illustrating a process of providing information according to another embodiment of the present invention.

### BEST MODE FOR CARRYING OUT THE INVENTION

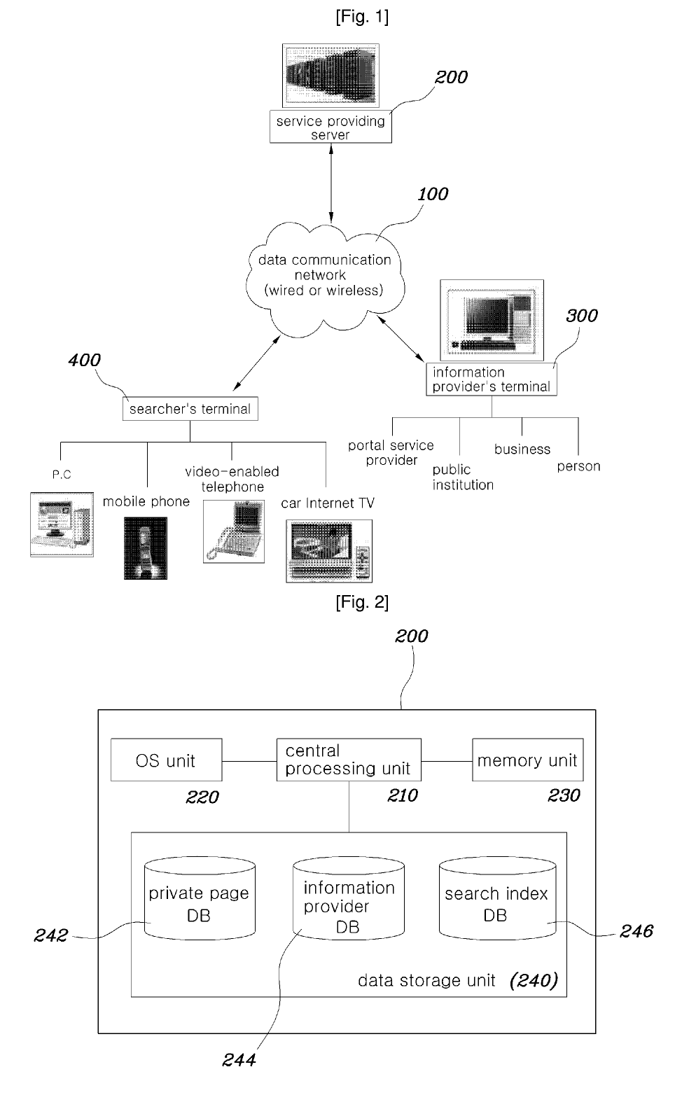

A method for providing information in a data communication network using a private page according to the present invention is described in more detail with reference to the accompanying drawings below. FIGS. 1 and 4 illustrate an information providing system to which the present invention is applied.

As shown in FIG. 1, the information providing system to which the present invention is applied includes a data communication network 100, a service providing server 200, an information provider's terminal 300, and a searcher's terminal 400.

The data communication network 100 includes all Internet networks using Transmission Control Protocol (TCP)/Internet Protocol (IP) that enables wired connection and Wireless Application Protocol (WAP) that enables wireless connection.

The service providing server 200 performs a function of registering the private page of the searcher's terminal 400 connected thereto through the data communication network 100, and searching for content received from the information provider's terminal 300 through a search window or a private search menu provided in the private page. For this purpose, the service providing server 200, as shown in FIG. 2, includes a central processing unit 210, an operating system unit 220, a memory unit 230 including Read-Only Memory (ROM) and Random Access Memory (RAM), and a data storage unit 240, and may further include a separate display unit although it is not shown.

The central processing unit 210 must be capable of performing functions of executing numerous mathematical calculations that are required when a large volume of task is processed and information is mutually exchanged, and searching databases, so that it is preferred that the central processing unit 210 generally be a higher class of central processing unit than that of Intel Co. 100 MHz P54C, Motorola Inc. 120 MHz Power PC604, or Sun Microsystems Inc. 166 MHz Ultra SPARC-1 series. Meanwhile, a separate Operating System (OS), which is necessary to operate the central processing unit 210, is stored in the operating system unit 220.

The memory unit 230 performs a function of temporally storing data according to the present invention, and may be any one of Electrically Erasable Programmable ROM (EEPROM), Dynamic Random Access Memory (DRAM), and Static Random Access Memory (SRAM) if the memory unit 230 has a size of more than 128 MegaBytes (MB).

The data storage unit 240 basically includes a private page DB 242, and an information provider DB 244, and may further include a search index DB 246, which is composed of pieces of information about searchers and information providers stored in the private page DB 242 and the information provider DB 244, in order to perform faster searching. The data storage unit 240 generally generates and manages DBs using a DB management program, such as software manufactured by Oracle Inc.

The private page DB 242 stores basic information about individual users who connect to the service providing server 200 to generate their private pages, and data for managing the private pages through an access program provided by the service providing server 200. The basic information may include personal information, such as names, resident registration numbers, phone numbers, addresses, and e-mail addresses that can enable individuals to be identified, as well as member Identifications (IDs) and passwords. The data necessary for managing the private pages may include pictures, media files (music, moving images and the like) and writings that are uploaded by individuals, but the present invention is not limited to these. The basic information and data may be changed by a corresponding searcher, and the changed basic information and data are updated in the private page DB 242 in real time.

The information provider DB 244 stores basic information about persons or businesses which desire to provide its own content using the access program provided by the service providing server 200. The basic information about a person or a business may include an ID for each member, a password, the name of business, the nationality, the address of the business, a business registration number, the contact person's name, the contact person's resident registration number, the address of the contact person, business classification, the category of business, and information about whether a directly managed site exists, the Uniform Resource Locator (URL) in the case where the site exist, the number of employees, and information for publicizing the person or business. In the case where a site managed by a person or a business does not exist, content to be provided may be directly stored in the information provider DB 244. The above-described details are only an exemplification, and the present invention is not limited to these.

The search index DB 246 separately stores only information that is extracted from information stored in the private page DB 242 and the information provider DB 244 and that can be used as a search index, such as names (firm names) or phone numbers that enable the identification of a person or a business. The search index may include numbers, characters, or a predetermined number of dots, which are determined by a combined searching system developed by the present inventor, based on the information.

Since the search index is basically the same as the information stored in the private page DB 242 and the information provider DB 244, it is not essential to separately construct the search index DB 246. However, the private page DB 242 and the information provider DB 244 stores various types of information along with information related to the search index, so that, if the search index DB 246 does not exist, the service providing server 200 must search for all the information stored in the private page DB 242 and the information provider DB 244 to extract a person or a business corresponding to the search index, therefore a long access time is required. In contrast, if information that can be used as a search index is previously extracted from information about the person or business and is stored in the search index DB 246, the search index DB 246 can be searched for alone, so that the search time can be effectively reduced.

The information provider's terminal 300 is used by persons or businesses which desire to provide its own information through the data communication network 100. For this purpose, the information provider's terminal 300 is a computer device that is capable of performing communication, and must include an Internet browser that is capable of displaying the details of web pages. Furthermore, the information provider's terminal 300 may include a Personal Computer (PC), such as a desktop computer or a notebook computer, a wired telephone, a mobile phone capable of wireless internet communication, and a PDA, as well as a server for a business.

Accordingly, the information provider's terminal 300 is not limited only to an entrepreneur who actually manages a specific business, may be a person who is managing a private page, such as a mini-homepages or a blog. Furthermore, it is not essential for a person or business using the information provider's terminal 300 to manage its own site, and simple information, such as a business introduction, may be stored in its own terminal or the service providing server 200 and then be directly transmitted when a search is requested.

The searcher's terminal 400 is used by a person who desire to connect to a private page provided by the service providing server 200 through the data communication network 100 and manages it, or to search for various types of content through the data communication network 100 and receives found content. The searcher's terminal 400 includes video-enabled telephones, home TeleVisions (TVs), or car internet TVs, which are connected to a data communication network used in an apartment, as well as desktop computers, notebooks, PDAs, Hand Personal Computers (HPCs), webpads, mobile phones, smart phones, Wireless Application Protocol (WAP) phones, palm PCs, an E-book terminals, or Hand Held Terminals (HHTs) that can transmit and receive text, still images, moving images, and sound data through wired or wireless communication.

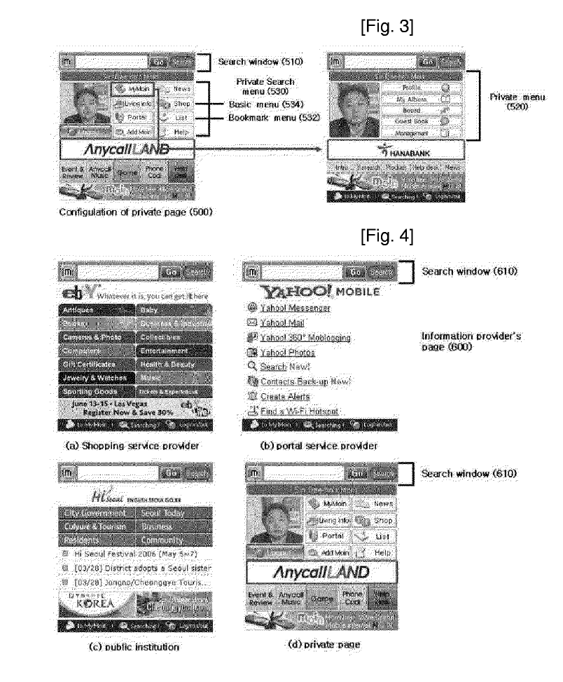

The present invention is technically characterized in that a search window and a private search menu are provided in a private page so that various types of content can be searched for in the private page provided by the service providing server 200 and then found content can be received. FIG. 3 is an embodiment of the private page formed to achieve this purpose, and illustrates a phone page provided through a wireless data communication network.

The private page 500 includes a search window 510, a private menu 520, and a private search menu 530. The search window 510 is configured such that a user connecting to the private page can directly input a predetermined search index and search for necessary content. The private menu 520 provides a menu necessary for the user's uploading or updating his or her introduction writings, pictures, or media files. The private search menu 530 is configured such that the user can select search indexes, to which content to be searched for belongs, in order, and, thus necessary information is received. Furthermore, the private search menu 530 includes a bookmark menu, such as an e-mail list that a user configures in person, and a basic menu, for such things as shopping, music, games, home networking, news searching, broadcasting and knowledge search, that users most frequently utilize.

In accordance with the present invention, the user can directly or indirectly search for necessary information through the search window 510 and the private search menu 530 provided in the private page that he or she manages in person, and receive found information, detailed descriptions of which are made later.

FIG. 4 shows an embodiment of a phone page related to the information provider provided from the service providing server 200 to the searcher's terminal 400. The information provider includes any person or business that desires to provide their own information through the data communication network 100, which may be a shopping service provider (a), such as Ebay or Auction, a portal service provider (b), such as Yahoo or Naver, or a public institution (c), such as the Seoul City Hall. Further, a person who manages the private page (d) generated by the service providing server 200 may also become the information provider.

The information provider's page provided by the service providing server 200 may be the page of a web site that the information provider manages in person, or a page generated by the service providing server 200. In accordance with the present invention, the information provider's page 600 is separately provided with a search window 610 even in both the pages, so that the user inputs a new search index through the search window 610, thus being capable of moving to a different information provider's page. This is another technical feature of the present invention, and overcomes the inconvenience of having to disconnect the wireless data communication network and having to reconnect in order to move to a different information provider's page when a search is performed using the conventional wireless data communication network.

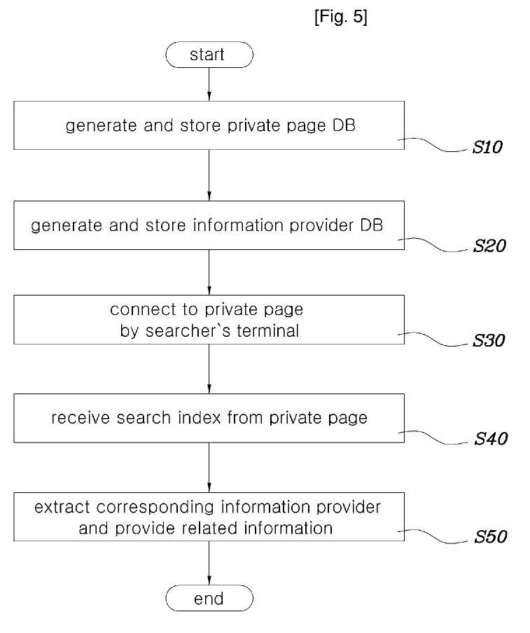

FIG. 5 is a flowchart illustrating a method for providing information according to the present invention.

First, the service providing server 200 receives necessary information from the searcher's terminal 400 through the data communication network 100, and generates and stores a private page DB 242 at step S10. In this case, the private page DB 242 stores basic information about individual users, and data necessary for managing the private page.

Thereafter, the service providing server 200 receives necessary information from the information provider's terminal 300 through the data communication network 100, generates and stores the information provider DB 244 at step S20. In this case, the information provider DB 244 stores basic information about persons or businesses which desire to provide their own information, using the access program provided by the service providing server 200. In the case where the information provider manages a separate site, the basic information may includes information necessary for connecting the user to the site of a corresponding information provider, like a web site URL. In the case where the information provider does not manage a separate site, the basic information may include information itself to be provided.

The step S10 of generating and storing the private page DB 242 and the step S20 of generating and storing the information provider DB 244 are repeatedly performed for the management of a system according to the present invention, and are events performed in parallel regardless the order thereof.

As described above, when the generation and storage of the private page DB 242 and the information provider DB 244 are completed, the service providing server 200 detects the connection of the searcher's terminal 400 to the private page through the data communication network 100 at step S30.

The service providing server 200, which has detected the connection, directly and indirectly receives a search index corresponding to information to be searched for from the searcher's terminal 400 through the search window 510 or the private search menu 530 provided in the private page at step S40. Accordingly, the user who connects to a private page can not only perform a basic task for managing the private page, such as uploading pictures or media files through the private menu 520, but also directly search for necessary information through the search window 510 and receive found information.

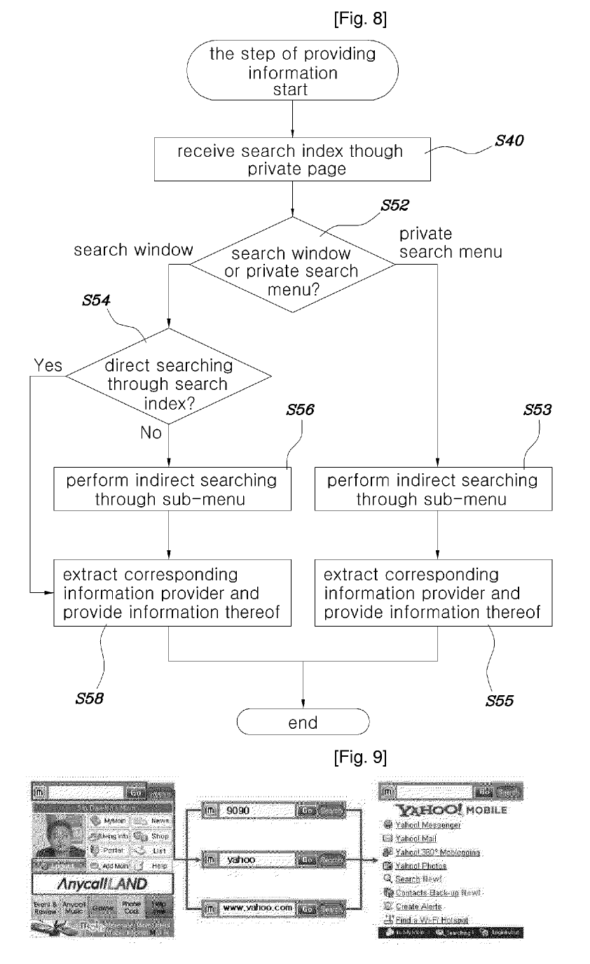

The service providing server 200 extracts an information provider corresponding to the received search index, and provides information related to the information provider to the searcher's terminal 400 or establishes a connection to a site that the information provider manages at step S50. The process of extracting the information provider corresponding to the received search index may be directly or indirectly performed through the search window 510, and may be only indirectly performed through the private search menu 530, the detailed descriptions of which are made with reference to FIGS. 8 to 11.

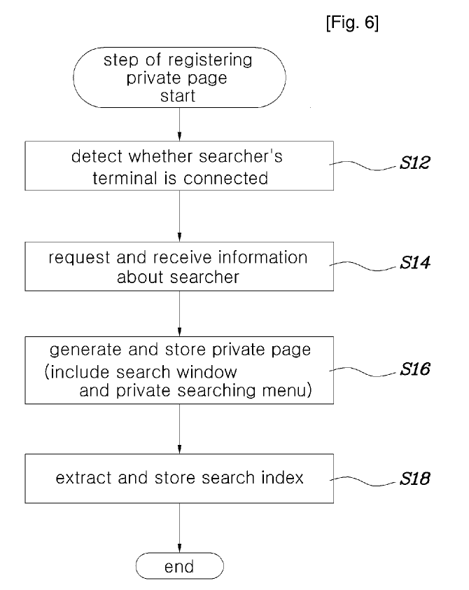

The step S10 of registering the private page is described in more detail with reference to FIG. 6.

First, the service providing server 200 detects the connection of the searcher's terminal 400 thereto for requesting the generation of the private page through the data communication network 100 at step S12. The detection may be performed by clicking a registration menu in the access program that the service providing server 200 provides.

Thereafter, the service providing server 200 requests and receives information necessary for generating the private page from the searcher's terminal 400 at step S14. The information necessary for generating the private page includes basic information, such as names, resident registration numbers, phone numbers, addresses, and e-mail addresses that can enable individuals to be identified, and data necessary for managing the private pages, such as pictures, media files (music, moving images and the like) and writings that are uploaded by individuals, as well as member IDs and passwords. As already described above, the basic information and the data are changed by the user and are updated in the private page DB 242 in real time.

The service providing server 200 generates a private page provided with the search window 510 and the private search menu 530 using the received information and stores the generated private page in the private page DB 242 at step S16, the step of basically registering the private page is completed. The search window 510 and the private search menu 530 are technical features according to the present invention, and allow the user to search for necessary information and receive found information in the private page.

Meanwhile, in accordance with the present invention, it is preferred that the step S18 of the service providing server 200 extracting a series of information, which is necessary to search for the private page, from the received information, and storing the extracted information in the search index DB 246 be further included. This step separately stores search indexes, thus allowing a searching task to be more quickly performed.

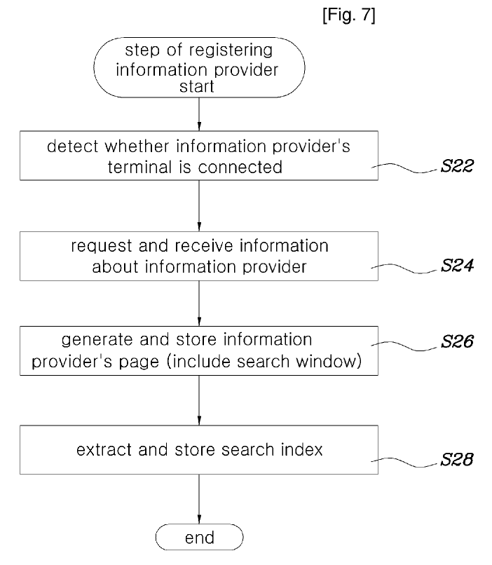

The step S20 of registering the information provider is described in more detail with reference to FIG. 7.

First, the service providing server 200 detects the connection of the information provider's terminal 300 thereto for requesting registration as the information provider through the data communication network 100 at step S12. The detection may be performed by the service provider connecting to the service providing server 200 and clicking a registration menu.

Thereafter, the service providing server 200 requests and receives information necessary for registering as an information provider from the information provider's terminal 300 at step S24. As already described above, the information necessary for registering as an information provider is an ID for each member, a password, the name of the business, the nationality, the address of the business, a business registration number, the contact person's name, the contact person's resident registration number, the address of the contact person, business classification, the category of business, and information about whether a directly managed site exists, the URL in the case where the site exist, the number of employees, and information for publicizing the person or business.

The service providing server 200 generates the information provider page provided with the search window 610 using the received information or generates the search window 610 in the page of the web site that the information provider manages, and then stores the generated results in the information provider DB 244 at step S26, so that the step of basically registering the information provider is completed. In the case where content to be provided is directly stored in the information provider DB 244 because the site that the information provider manages does not exist, the service providing server 200 directly generates and stores the information provider page in which the search window 610 is contained. Furthermore, even in the management of content (a shopping mall and the like) that the service providing server 200 itself provides, the service providing server 200 directly generates and stores the information provider page.

In the case where the information provider manages a separate web site, the service providing server 200 stores information necessary for connecting the page of the web site that the information provider manages to the searcher's terminal 400. However, even in this case, the search window 610 is separately provided in the page of the information provider's site.

Meanwhile, in accordance with the present invention, it is preferred that the step S28 of the service providing server 200 extracting a series of information, which is necessary to search for the information provider, from the received information and storing the extracted information in search index DB 246 be further included. This step separately stores search indexes, thus allowing a searching task to be more quickly performed.

The step S50 of proving information is described in more detail with reference to FIGS. 8 to 11.

First, the service providing server 200, having received a search index through the private page at step S40, determines whether the received search index is input through the search window 510 or is selected through the private search menu 530 at step S52.

In this case, the search index may include numbers, characters, or a predetermined number of dots, and allows the information provider to be directly extracted through the search window 510 or to be indirectly extracted through a sub-menu linked to the search window 510 or the private search menu. The search index system may utilize the present inventor's wired and wireless combined search system that is developed using numbers, the detailed description of which is described in Korean Unexamined Pat. No. 2003-0007983.

If, as the result of determination at step S52, the search index is input through the search window 510, the service providing server 200 searches for the information stored in the search index DB 246 and determines whether the received search index corresponds to a predetermined information provider at step S54. If there exists information corresponding to the received search index, the service providing server 200 provides the page of a corresponding information provider to the searcher's terminal 300. An embodiment with respect to this is illustrated in FIG. 9. Yahoo, which is a portal service provider, can be directly searched for using a number index of “9090”, a character index of “Yahoo”, or a URL index of “www.yahoo.com” Accordingly. When the user inputs one of the three indexes through the search window 510, the service providing server 200 extracts Yahoo, which is an information provider corresponding to the input index, and provides the page of the web site thereof at step S58.

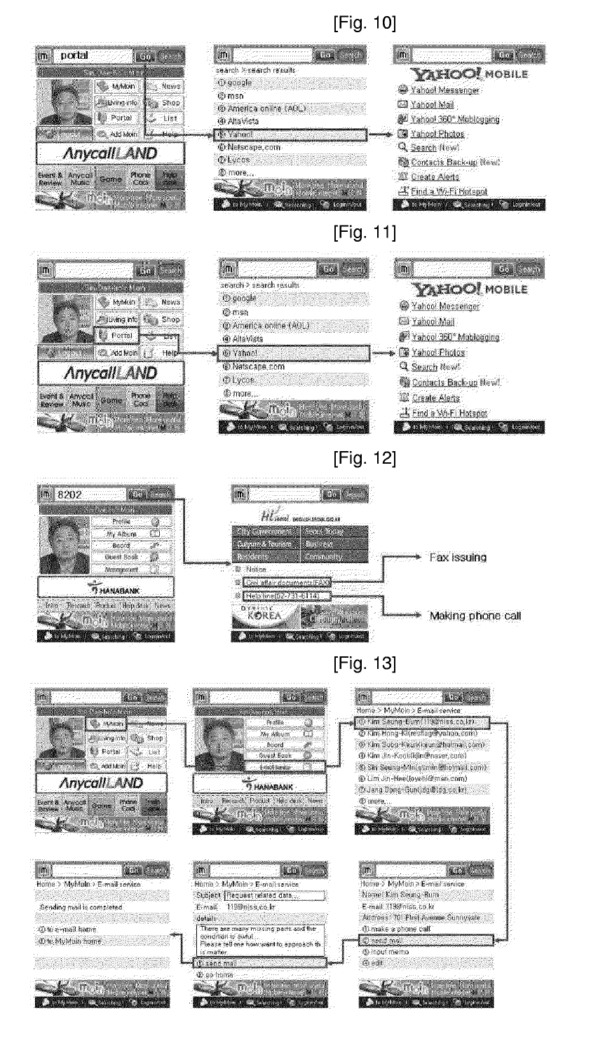

In contrast, when information directly corresponding to the received search index does not exist, the service providing server 200 provides a sub-menu related to the search index and allows the corresponding information provider to be searched for at step S56. An embodiment with respect to this is illustrated in FIG. 10. When the user inputs “Portal” in the search window 510, the service providing server 200 provides the registered portal service provider as a sub-menu. Thereafter, when the user selects Yahoo, to be searched for in person, in the sub-menu, the service providing server 200 provides the page of the web site thereof at step S58.

Meanwhile, if, as a result of the determination at step S52, the search index is input through the private search menu 530, the service providing server 200 provides sub-menus related to the private search menu 530, thus allowing a corresponding information provider to be searched for at step S53. In other words, if the user selects the private search menu 530, the service providing server 200 provides a series of sub-menus related to the private search menu 530, the user receives desired information by selecting the provided sub-menus in order according to the classification to which the information provider to be searched for belongs.

An embodiment with respect to this is illustrated in FIG. 11. When the user selects the private search menu 530, a sub menu having a broad classification list, such as portal, music, game, home networking and news searching, is provided. When the user selects a portal menu to which a portal service provider to be searched for belongs in the broad classification list, another sub-menu having a narrow classification list, such as google, msn, America online, AltaVista, Yahoo, Netscape or Lycos is provided. When the user finally selects Yahoo from the narrow classification list, the service providing server 200 provides a corresponding page.

As described above, the service providing server 200 directly or indirectly extracts the information provider to be searched for using a search index input through the search window 510 or the private search menu 530 provided in the private page that the user manages in person, and directly provides a page related to the extracted information provider or links the user to a site that the information provider manages.

In accordance with the present invention, various functions, other than the function of searching for necessary information and receiving found information through the private page that the user manages, can be performed by the user. An embodiment with respect to this is illustrated in FIG. 12. The user inputs a search index of “8202” through the search window of his or her private page, and directly connects to the Department of Housing of Seoul City Hall. Thereafter, the user may be issued a necessary document through a fax using an “Civil affairs documents” menu provided in the page of the Department of Housing of Seoul City Hall, and can directly communicates with a charger using a “Help line” menu.

The fax issuing and phone call functions are performed in the state in which a connection with the wireless data communication network is maintained. These functions are very convenient compared to the conventional one of having to find out the phone number of the department of Housing of Seoul City Hall through a wireless data communication network, having to disconnect from the wireless data communication network, and separately make a phone call. In accordance with the present invention, the user can search for necessary information through his or her private page, and completely process the following work in the private page.

Meanwhile, the private search menu 530 according to the present invention may include basic provision of the service providing server 200, and setting of personal preferences using bookmarked information received from the searcher's terminal 400. As an embodiment with respect to this, the private search menu 530 may include the bookmark menu 532 that the user directly sets, such as an e-mail list, and the basic menu 534, for such things as shopping, music, games, home networking, news searching, broadcasting and knowledge search, that users most frequently utilize, which is already described with reference to FIG. 3.

An example of using the bookmark menu 532 is illustrated in FIG. 13. The user selects a private search menu, e-mail, and a person targeted for the e-mail in order in the private page that the user manages in person, and inputs necessary details, thus being capable of sending a desired e-mail. The e-mail function can also be performed in the state in which a connection with the wireless data communication network is maintained. This function is very convenient because it can be performed in a private page, instead of the conventional method of disconnecting from the wireless data communication network and performing transmission using an e-mail function that is separately provided by a mobile phone.

When the described function is extended with reference to FIGS. 12 and 13, the present invention can provide a one-stop service system for performing all tasks desired in the private page that the user manages in person.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for providing information in a data communication network using a private page, the method comprising the steps of:
(a) a service providing server receiving required information from a searcher's terminal through a data communication network, and generating and storing a private page DataBase (DB);
(b) the service providing server receiving required information from an information provider's terminal through the data communication network, and generating and storing an information provider DB;
(c) the service providing server detecting the connection of the searcher's terminal to a private page through the data communication network;
(d) the service providing server receiving a search index with respect to information to be searched for from the searcher's terminal through a search window or a private search menu provided in the private page; and
(e) the service providing server extracting an information provider corresponding to the received search index, and then providing information about the extracted information provider to the searcher's terminal or linking the searcher's terminal to a site managed by the extracted information provider.

2. The method as set forth in claim 1, wherein the step (a) further comprises the steps of:
(a-1) the service providing server detecting a connection of the searcher's terminal thereto for requesting generation of the private page through the data communication network;
(a-2) the service providing server requesting the information required to generate the private page, from the searcher's terminal, and receiving the corresponding information; and
(a-3) the service providing server generating the private page, wherein the search window and the private search menu are provided within the private page, using the received information, and storing the generated page to the private page DB.

3. The method as set forth in claim 2, wherein the step (a-3) further comprises the step of the service providing server extracting a series of search indexes required to search for the private page from the received information, and storing the extracted indexes to a search index DB.

4. The method as set forth in claim 1, wherein the step (b) further comprises the steps of:
(b-1) the service providing server detecting a connection of an information provider's terminal thereto for requesting registration as an information provider through the data communication network;
(b-2) the service providing server requesting information required to register the information provider from the information provider's terminal, and receiving the corresponding information;
(b-3) the service providing server generating an information provider page in a search window or generating a search window on a page of a web site managed by the information provider, and then storing the generated search window to the information provider DB.

5. The method as set forth in claim 4, wherein step (b-3) further comprises the step of the service providing server extracting a series of search indexes required to search for the information provider, from the received information, and storing the extracted indexes to a search index DB.

6. The method as set forth in claim 1, wherein, at step (d), the search index includes numbers, characters, or a predetermined number of dots, and is configured to allow the information provider to be directly extracted through the search window or to be indirectly extracted through a sub-menu linked to the search window or the private search menu.

7. The method as set forth in claim 6, wherein step (e) further comprises the steps of:
(e-1) the service providing server determining whether the received search index has been received through the search window or the private search menu;
(e-2) the service providing server directly extracting the information provider using the search index or indirectly extracting the information provider through a sub-menu linked to the search window if it is determined that the search index is received through the search window;
(e-3) the service providing server indirectly extracting the information provider through the sub-menu linked to the private search menu using the search index if it is determined that the search index is received through the private search menu; and
(e-4) the service providing server directly providing a page related to the extracted information provider to the searcher's terminal, or linking the searcher's terminal to a site managed by the extracted information provider.

8. The method as set forth in claim 1, wherein, at step (d), the private search menu is a menu provided by the service providing server, or a menu set up according to personal preference using bookmarked information received from the searcher's terminal.
